(19) United States
(12) Patent Application Publication
(10) Pub. No.: US 2004/0003533 A1
(43) Pub. Date: Jan. 8, 2004

(54) Dual hook fishhook

(76) Inventor: Malvin Leslie Larsen, Cape Coral, FL (US)

Correspondence Address: Malvin Leslie Larsen, 1303 SW 7th Terr., Cape Coral, FL, 33991, US

(21) Appl. No.: 10/384,802

(22) Filed: Jul. 8, 2002

(51) Int. Cl. A01K 83/06

(52) U.S. Cl. 43/44.82

(57) ABSTRACT

The invention is directed to a fishhook having double hooks thereon. There is a single shank with an eyelet thereon to be fastened to a fishing line. From the top of the shank there emerge two wires in an outward manner. The ends of the wires are each formed into a hook that is bent into a circle of about 180°. The two half circles are oriented in opposite directions relative to each other. The ends of the hooks have each a pointed barb thereon which are bent outwardly relative to each other and relative to the each of the half circles.

### CROSS REFERENCE TO RELATED APPLICATIONS

(none)

### STATEMENT REGARDING FED SPONSORED R&D

(none)

### BACKGROUND OF THE INVENTION

1. Field of the Invention

The invention relates to a fishhook, and more particularly to an improved fishhook having dual but opposed hooks emanating from a single shank.

2. The Prior Art

Fishhooks having sharp hooks, that is, barbed hooks thereon are well known in the prior art and in use, but fishhooks having two hooks but opposed to each other have not been found.

U.S. Pat. No. 4,060,928 discloses a single fishhook that is so designed or having means thereon for causing the fishhook to rotate while in the fish's mouth to a horizontal position. The invention at hand causes the fish hook to rotate but not into a horizontal direction and for entire different reasons.

U.S. Pat. No. 4,214,398 shows a fishhook having a single hook having an offset bend in the shank which acts as a lever to turn the hook as pressure is applied to the line so as to engage the point in the flesh of the fish regardless of the angle at which pressure is applied to the line.

U.S. Pat. No. 4,506,469 illustrates a fishhook having twin hooks thereon. The two hooks are pivotally connected to each by way of a pivot pin. The two hooks are pointed relative to each other but in opposite directions. The two hooks also move relative to each other but in the same plane. The two hooks in the invention at hand do not move relative to each other but are rigidly connected to a single shank.

U.S. Pat. No. 4,835,898 illustrates a single hook fishhook having a lateral bend in the shank of the hook but the tip of the hook is perfectly aligned with the eyelet on the shank of the fishhook.

U.S. Pat. No. 4,854,070 shows a self-setting fishhook that is automatically set in the fish by contact with the fish, the setting of the hook requiring no action from the fisherman.

U.S. Pat. No. 4,998,373 illustrates a double hook lure including a pair of shanks having piercing barbs. The shanks have first bends causing them to diverge from each other in a shank plane from a lead head in which their ends are embedded. The invention at hand requires that the two hooks are displayed in the opposite direction which is not the case in this patent.

U.S. Pat. No. 5,237,772 shows a double hook fishhook arrangement by which the two hooks are located or placed far removed from each other.

U.S. Pat. No. 5,115,594 illustrates the use of a treble hook fishhook all combined into one shank. The three bight portions of the treble fishhook are equally spaced about the axis of the shank. The disclosure of this patent does not indicate that the hook portions of the treble hook arrangement are not further bent into another direction as will be shown below.

U.S. Pat. No. 5,941,014 shows a composite fishhook which provides multiple barbs of a main hook part and a dependent hook part that is attached mechanically and physically to the main hook part. The dependent hook has two opposing hook parts which must act in unison which is not an object of the invention at hand.

U.S. Pat. No. 5,890,314 reveals a fishing hook including two hooks that are constructed in one unit but spaced apart in an elastic manner. This is not the subject of the invention at hand.

### BRIEF DESCRIPTION OF THE DRAWINGS

FIG. 1 is a perspective view of the dual hook fishhook

FIG. 2 is a front view of the fishhook

FIG. 3 is a side view of the fishhook;

FIG. 4 is a top view of the fishhook.

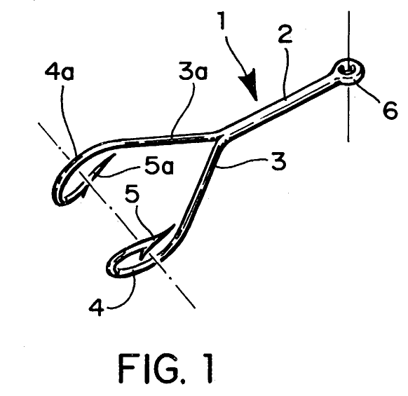

### DETAILED DESCRIPTION OF THE INVENTION

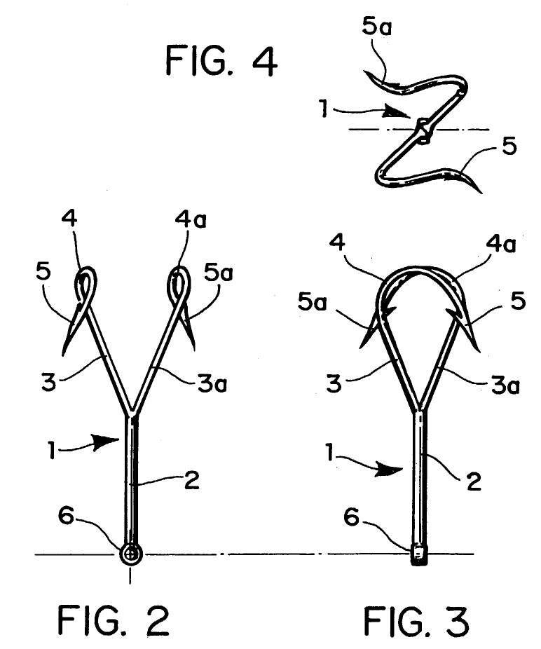

It is to be noted that all the same reference characters appear in all of the different views. The overall fishhook appears as 1 in all of the different views. The fishhook consists of a single shank 2 having an eyelet 6 therein. The single shank is made up of two individual wires 3 and 3a that are combined into one shank 2 by using various connection features such as gluing, wrapping or welding. It is also quite possible to make the inventive fishhook out of one piece of wire. On the other hand, the fishhook can be made out of single and identical wires and then combined into a single shank with the outer barbed points being turned into opposite directions. As can be seen in all of the FIGS., the individual wires 3 and 3a emanating from the single shank 2 are spreading apart away from the single shank 2, that is sideways in FIG. 2 or backward and forward in FIG. 3. Thereafter, the individual wires 3 and 3a undergo a half circle of about 180° at 4 and 4a with the ends pointing in opposite directions. At the completion of the half circles 4 and 4a the ends of each of the half circles 4 and 4a point straight ahead and are then formed into barbed hooks 5 and 5a.

As can be seen from FIGS. 2 and 4, the barbed hooks are further bent in a direction away from each other or out of the plane of the half circles. As a matter fact, the ends of the half circle follow already this bending of the ends outwardly.

### OPERATION OF THE INVENTION

The bait, such as a live worm for example, may be attached to one hook, across both hooks or one on each of the hooks 5 and 5a. The first time a fish bites, it does not matter on which hook, the slightest tug or push will automatically rotate the entire hook because of the eccentric mounting of the hooks on the fishing line. As the hook is rotated, the other hook swinging around will enter the flesh of the fish. As a matter of fact, no tug on the fish line is necessary or required.

Experiments and experience have shown that out of 26 tries of fishing all 26 were successful in catching the fish and at 6 tries in row, the bait survived and did not have to replaced.

What I claim is:

1. A fishhook having two hooks thereon, said fishhook being constructed with a single shank, each of the hooks is spread upwardly and outwardly as they emerge from said single shank, thereafter each of the hooks is turned in a half circle of about 180° but in opposite directions, the ends of each of the hooks has a barbed point thereon, each of said barbed points is turned away from each other in a plane which is outward and in opposite directions.

2. The fishhook of claim 1, wherein said fishhook is constructed out of one single wire.

3. The fishhook of claim 1, wherein said hooks is made out two identical wires combined into a single shank but with said barbed points facing in opposite directions.
